(19) United States
(12) Patent Application Publication
(10) Pub. No.: US 2003/0164024 A1
(43) Pub. Date: Sep. 4, 2003

(54) Biosensor and method for production thereof

(75) Inventors: Kohji Mitsubayashi, Tokyo (JP); Katsuei Aoyagi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Rikei Corporation, Tokyo (JP)

(21) Appl. No.: 10/235,070

(22) Filed: Sep. 4, 2002

(30) Foreign Application Priority Data
Mar. 4, 2002 (JP) 2002-057130

(51) Int. Cl. G01N 21/76

(52) U.S. Cl. 73/23.34; 436/164

(57) ABSTRACT

A biosensor comprising an enzyme immobilized membrane in intimate contact with the front end of an optical fiber is disclosed. The biosensor can be produced by coating and impregnating a dialysis membrane with an enzyme and a photocrosslinkable resin, and then crosslinking the photocrosslinkable resin to immobilize the enzyme in the dialysis membrane, thereby obtaining an enzyme immobilized membrane; and bringing the enzyme immobilized membrane into intimate contact with the front end of an optical fiber. Since the optical fiber and the enzyme (enzyme immobilized membrane) are used in combination, the biosensor is highly sensitive and selective and can serve as an excellent odor sensor.

The entire disclosure of Japanese Patent Application No. 2002-057130 filed on Mar. 4, 2002 including specification, claims, drawings and summary is incorporated herein by reference in its entirety.

### BACKGROUND OF THE INVENTION

1. Field of the Invention

This invention relates to a biosensor, and more particularly, to a biosensor with high sensitivity and excellent selectivity which uses an optical fiber and an enzyme in combination. The biosensor of the present invention is used for detecting and measuring an odor component, in particular.

2. Description of the Related Art

Many biosensors, which utilize optical reactions such as luminescence, fluorescence and quenching, have been reported in recent years. Biosensors refer to sensors which utilize the molecular recognition function of biological materials, such as microorganisms, enzymes and antibodies, and apply the biological materials as molecular recognition elements. In other words, biosensors are designed such that reactions, which occur when immobilized biological materials recognize the target substrates, for example, consumption of oxygen by respiration of microorganisms, enzyme reaction, and luminescence, are converted into electrical signals by physical and chemical devices, and measurements are made based thereon.

Development is under way, particularly, for practical use of enzyme sensors among biosensors. For example, enzyme sensors for glucose, lactic acid, cholesterol, etc. have been developed, and find use in fields such as medical care and food industry. Enzyme sensors reduce electron acceptors, which are generated by reactions of enzymes with substrates contained in sample solutions, and allow measuring devices to electrochemically measure the amounts of the electron acceptors reduced or oxidized, thereby making quantitative analysis of samples.

Development for practical use of optical fiber sensors is also under way, and these sensors begin to find various applications. A fluorescence reaction of a ruthenium complex undergoes quenching according to the ambient oxygen concentration. Oxygen-sensitive optical fiber sensors under development utilize this fluorescence quenching, and have a ruthenium complex fixed to an optical fiber, enabling the oxygen concentration to be measured.

As described above, biosensors and optical fiber sensors are applied in various fields. However, there have been no reports that these sensors were used in measuring odors. Thus, they are expected to be put to such uses.

Varieties of odor sensors have hitherto been developed and used, but their sensitivity and selectivity are not sufficient, and odor sensors with high sensitivity and selectivity have been desired.

### SUMMARY OF THE INVENTION

The present invention has been accomplished in light of the circumstances described above. Its object is to provide a biosensor (odor sensor) having high sensitivity and selectivity by using an optical fiber and an oxidoreductase (an oxidoreductase immobilized membrane) in combination.

To attain the above object, the inventors conducted in-depth studies, and obtained the finding that this object can be achieved by bringing a membrane, which has an enzyme immobilized therein, into intimate contact with the front end of an optical fiber.

According to an aspect of the present invention, there is provided a biosensor comprising an enzyme immobilized membrane in intimate contact with the front end of an optical fiber. The combined use of the optical fiber and the enzyme immobilized membrane (oxidoreductase) gives a highly sensitive, highly selective biosensor.

According to another aspect of the present invention, there is provided an odor measuring device having at least one such biosensor. The odor measuring device with a plurality of the biosensors of the invention can measure a plurality of odor components.

According to yet another aspect of the present invention, there is provided a method for producing a biosensor, comprising the steps of coating and impregnating a dialysis membrane with an oxidoreductase and a photocrosslinkable resin, and then crosslinking the photocrosslinkable resin to immobilize the oxidoreductase in the dialysis membrane, thereby obtaining an oxidoreductase immobilized membrane; and bringing the resulting oxidoreductase immobilized membrane into intimate contact with the front end an oxygen-sensitive optical fiber. This method, using the optical fiber and the oxidoreductase in combination, can easily produce a biosensor with high sensitivity and excellent selectivity.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIGS. 1(a) and 1(b) are enlarged views of a front end portion of an embodiment of a biosensor according to the present invention;

FIG. 2 is an enlarged sectional view of a front end portion of a biosensor according to a second embodiment of the present invention;

FIG. 3 is a graph showing the responsiveness of the biosensor to an ethanol gas;

FIG. 4 is a graph showing a plot of the output steady-state values of the biosensor under an ethanol gas load; and

FIG. 5 is a graph showing the responsiveness of the biosensor to an ethanol gas.

### DESCRIPTION OF THE PREFERRED EMBODIMENTS

The biosensor of the present invention will now be described in detail.

The biosensor of the present invention is characterized in that an enzyme immobilized membrane is in intimate contact with the front end of an optical fiber.

Examples of the optical fiber used in the biosensor of the invention are an oxygen-sensitive optical fiber, a pH-sensitive optical fiber, and a luminescence-sensitive optical fiber. The oxygen-sensitive optical fiber is an optical fiber which can detect the concentration of oxygen by utilizing the phenomenon that a fluorescence reaction undergoes quenching according to the ambient oxygen concentration. The pH-sensitive optical fiber and the luminescence-sensitive optical fiber are optical fibers which can measure pH and luminescence, respectively.

The oxygen-sensitive optical fiber used in the biosensor of the present invention may be one having a ruthenium organic complex fixed to an optical fiber in view of the phenomenon that a fluorescence reaction of the ruthenium organic complex undergoes quenching according to the ambient oxygen concentration. The oxygen-sensitive optical fiber is not limited to those having ruthenium organic complexes fixed to optical fibers. Optical fibers having organic complexes of, for example, osmium, iridium, rhodium, rhenium and chromium fixed thereto are also usable as the oxygen-sensitive optical fibers of the invention.

The organic complexes herein include, for example, complexes of ruthenium with 2,2′-bipyridine, 1,10-phenanthroline, 4,7-diphenyl-1,10-phenanthroline, 4,7-dimethyl-1,10-phenanthroline, 4,7-disulfonyldiphenyl-1,10-phenanthroline, 2,2′-bi-2-thiazoline, 2,2′-bithiazole, 5-bromo-1,10-phenanthroline, and 5-chloro-1,10-phenanthroline.

The method of fixing the ruthenium complex or the like to the front end of the optical fiber is not limited, but the sol-gel method, for example, can be adopted for fixing. A fluorescence reaction of a ruthenium complex (excitation light: 470 nm, fluorescence: 600 nm) shows a quenching phenomenon sensitive to the concentrations of oxygen and dissolved oxygen in a vapor phase and a liquid phase, respectively, in the presence of oxygen. Thus, the oxygen concentration can be measured.

The oxygen-sensitive optical fiber for use in the present invention may be a commercially available product. For example, an optical fiber of Ocean Optics can be employed. The diameter of the optical fiber used can be selected according to uses, and the product of about 1.5 mm is usually used. However, the diameter of the optical fiber is not limited to this dimension, and the optical fiber with a diameter in the range of 0.01 to 5.0 mm can be used.

As the enzyme used in the biosensor of the present invention, oxidoreductases, dehydrogenases or luminescent enzymes are named.

The oxidoreductases used in the biosensor of the present invention are enzymes which consume or generate oxygen upon reaction with substrates. Such oxidoreductases can be selected depending on the substrate to be measured. Alcohol oxidases are used to measure the concentration of ethanol. Flavin-containing monooxygenases are used for measurement of the concentration of trimethylamine, methyl mercaptan, or ammonia. Other oxidoreductases for use in the biosensor of the invention include, for example, catalases, monoamine oxidases, and lactic acid oxidases.

Other combinations of enzymes and optical fibers used in the biosensor of the present invention are as follows:

In the biosensor of the invention, an aldehyde dehydrogenase and a pH-sensitive optical fiber, for example, are used in combination. The aldehyde dehydrogenase eliminates hydrogen from aldehyde, whereupon the pH of the solution changes. This change in pH is detected by the pH-sensitive optical fiber, whereby an aldehyde, such as acetaldehyde, can be measured. Formaldehyde can also be measured by using a formaldehyde dehydrogenase.

When an alcohol dehydrogenase and the pH-sensitive optical fiber are used in combination, hydrogen is eliminated from alcohol by the action of the alcohol dehydrogenase, and the pH of the solution changes. This change in pH is detected by the pH-sensitive optical fiber, whereby alcohol can be measured.

In the biosensor of the invention, it is possible to use an alcohol oxidase, a luciferase, and a luminescence detection type optical fiber in combination. Luciferase consumes hydrogen peroxide in producing luminescence. The alcohol oxidase consumes oxygen, and the resulting hydrogen peroxide is detected by the intensity of luminescence by luciferase. In this manner, alcohol can be detected.

Methods for preparing the enzyme immobilized membrane used in the biosensor of the invention include, for example, entrapment in photocrosslinkable resin, crosslinking, and adsorption. Of these methods, entrapment in photocrosslinkable resin is generally used. This entrapment in photocrosslinkable resin will be described below.

Examples of the photocrosslinkable resin used in preparing the enzyme immobilized membrane of the biosensor of the invention are polyethylene glycol and polyvinyl alcohol. PVA-SbQ (SPP-H-13(Bio), Toyo Gosei Kogyo Kabushiki Kaisha), a combination of polyvinyl alcohol and a photosensitive group of SbQ, can be used.

The membrane used in the biosensor of the invention is usually a dialysis membrane. The dialysis membrane is not limited, and may be any commercially available product. Normally, a dialysis membrane with a thickness of about 15 μm is used, but the membrane with a thickness of about 15 μm is not restrictive.

The membrane containing the oxidoreductase and the photocrosslinkable resin, which is used in the present invention, can be produced in the following manner:

The dialysis membrane is coated and impregnated with the oxidoreductase and the photocrosslinkable resin. Then, the photocrosslinkable resin is crosslinked, whereby the oxidoreductase is immobilized in the dialysis membrane to form an oxidoreductase immobilized membrane. This method will be described in detail in an explanation (to be offered later) for the method for producing the biosensor of the invention.

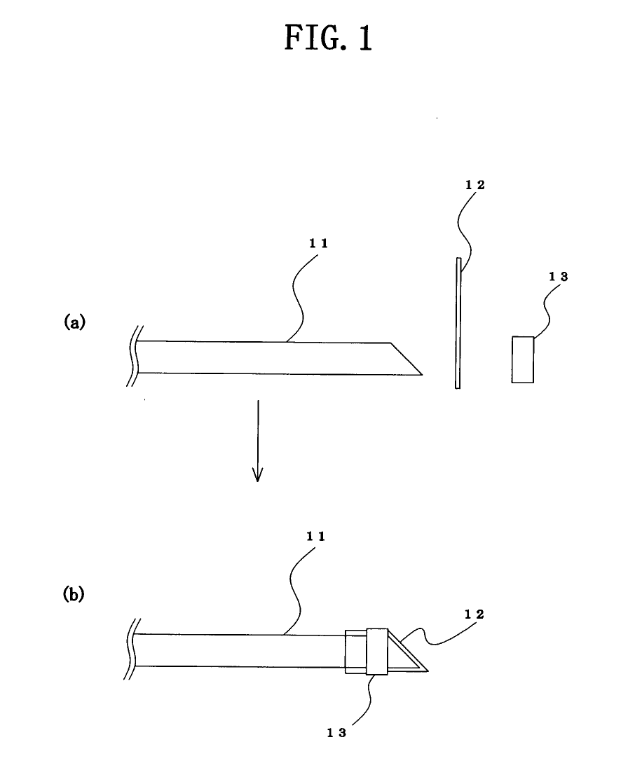

Enlarged views of a front end portion according to an embodiment of the biosensor of the invention are shown in FIGS. 1(a) and 1(b). As shown in these drawings, an oxidoreductase immobilized membrane 12 is in intimate contact with the front end of an optical fiber 11, and the oxidoreductase immobilized membrane 12 is fixed to a front end portion of the optical fiber 11 by a silicone tube ring 13. The biosensor shown in FIGS. 1(a) and 1(b) has its front end portion formed at an angle of about 45°. In the biosensor of the present invention, its front end portion is not limited to that formed at an angle of about 45°, but its front end may be flat. The biosensor having a front end portion shaped at an angle of about 45° can measure a substrate by being stuck into a sample. The thickness of the oxidoreductase immobilized membrane 12 used in the biosensor of the present invention is not limited, but may be of the order of 15 μm.

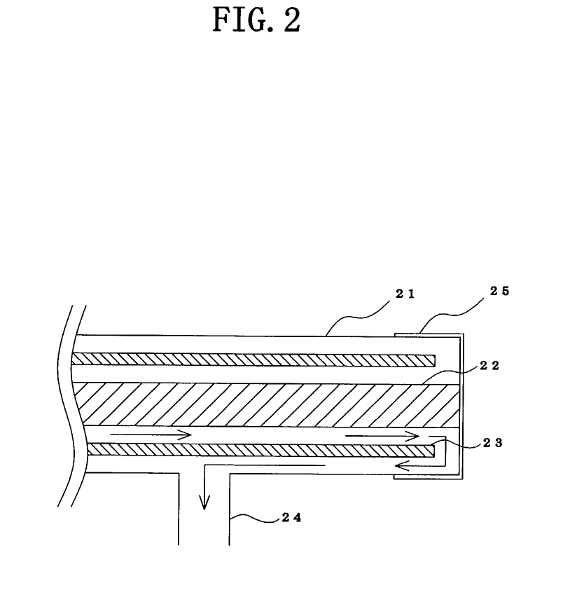

A second embodiment of the biosensor of the present invention will be described with reference to FIG. 2. FIG. 2 is an enlarged sectional view of a front end portion of a biosensor according to a second embodiment of the present invention. The biosensor shown in FIG. 2 has an optical fiber 22 inserted into a tubular body 21, and a liquid can be circulated in the tubular body 21.

A discharge pipe 24 is connected to the side surface of the tubular body 21, and a partition tube 23 is provided between the side surface of the tubular body 21 and the optical fiber 22. An enzyme immobilized membrane 25 is in intimate contact with the front end of the biosensor. In the biosensor shown in FIG. 2, a liquid is circulated in a flow as indicated by arrows, and the liquid is discharged through the discharge pipe 24. The circulating liquid flows into the tubular body 21 through a liquid inlet (not shown) for circulation.

The liquid refers, for example, to a buffer, and a buffer having a pH close to the optimal pH of an oxidoreductase immobilized in the enzyme immobilized membrane 25 is used. This buffer circulates within the tubular body 21, producing the effect of cleaning a front end portion of the optical fiber 22. Because of this cleaning effect, gas components and enzyme products to be measured do not remain at the front end of the optical fiber 22, so that continuous measurement can be made.

The buffer can incorporate necessary substances for an enzyme reaction of the oxidoreductase immobilized in the enzyme immobilized membrane 25. For example, when a flavin-containing monooxygenase is used as the oxidoreductase, the flavin-containing monooxygenase requires β-NADPH as a coenzyme and ascorbic acid as a reducing agent. Thus, β-NADPH and ascorbic acid may be incorporated into the buffer.

To measure an odor component with the use of the biosensor of the present invention, changes in fluorescence intensity are monitored with a computer via a spectroscope and an A/D converter. The measurement can be made in an ordinary optical environment (a laboratory under a fluorescent lamp) without using a dark room or a black box.

The biosensor shown in FIGS. 1(a) and 1(b) has a front end formed at an angle of about 45°, and when the front end of the biosensor is stuck into a sample bag filled with a sample, odor components in the sample in the sample bag can be measured.

The odor measuring device of the present invention has at least one biosensor according to the present invention. An odor measuring device, which can measure ethanol and trimethylamine simultaneously, can be produced by using, in combination, a biosensor using an alcohol oxidase as an oxidoreductase and a biosensor using a flavin-containing monooxygenase as an oxidoreductase. The combined use of plural biosensors, which use different oxidation-reduction enzymes, makes it possible to measure odors of a sample incorporating a plurality of odors.

With the recent development of information communications, rapid advances have been made in the communication of visual information, such as a pictorial image, and auditory information, such as voice. In addition to the communication utilizing visual and auditory information, expectations are growing of the realization of communication which can integrally utilize information from the five senses including olfactory sense, tactile sense and gustatory sense.

The odor measuring device using the biosensor of the present invention can measure a plurality of odor components. If the results of the measurement of the plural odor components by the odor measuring device are conveyed by information communication, the receiver blends the odor components based on the results of analysis, and can reproduce a particular odor. More concretely, it is possible, for example, to construct an odor generator which, based on the results of analysis of odor components measured by the odor measuring device of the present invention, mixes the respective odor components according to the results of their analysis to generate a particular odor.

Next, the method for producing the biosensor of the present invention will be described.

The method for producing the biosensor of the invention comprises the step of coating and impregnating a dialysis membrane with an enzyme and a photocrosslinkable resin, and then crosslinking the photocrosslinkable resin to immobilize the enzyme in the dialysis membrane, thereby obtaining an oxidoreductase immobilized membrane; and the step of bringing the resulting enzyme immobilized membrane into intimate contact with the front end an optical fiber.

In the method for producing the biosensor of the invention, the dialysis membrane is coated and impregnated with the enzyme and the photocrosslinkable resin. As the enzyme and the photocrosslinkable resin, those described in connection with the aforementioned biosensor of the present invention can be used. In this method, the enzyme and the photocrosslinkable resin are mixed to form a paste. Examples of a solvent for use in preparing the paste are buffers, distilled water, and ion exchanged water. The mixing ratio of the enzyme and the photocrosslinkable resin is preferably such that the enzyme and the photocrosslinkable resin are used in nearly the same amount. A mixture of the enzyme and the photocrosslinkable resin is suspended in the solvent to form a paste. The amount of the solvent used is about 1:1 relative to the mass of the enzyme and the photocrosslinkable resin.

Then, the paste obtained as above is coated onto a dialysis membrane. The dialysis membrane used is preferably one having a thickness of the order of 1 to 1,000 μm. Usually, the dialysis membrane has a thickness of the order of 15 μm. The amount of the paste coated is 0.01 to 1 mg/mm². Then, the paste-coated dialysis membrane is allowed to stand in a cold dark place (at a temperature of 0 to 10° C.) until it becomes dry. The drying time is not limited, but may be in a matter of 30 minutes to 2 hours. Then, the dialysis membrane is irradiated with light from a fluorescent lamp for photocrosslinking. By so entrapping and immobilizing the enzyme, an enzyme immobilized membrane is obtained. The irradiation with light from the fluorescent lamp lasts for a matter of 15 minutes to 1 hour.

Then, the resulting enzyme immobilized membrane is brought into intimate contact with the front end of an optical fiber. This process is described with reference to FIGS. 1(a) and 1(b). FIGS. 1(a) and 1(b) are views showing a process chart for production of the biosensor of the present invention. In these drawings, the numeral 11 denotes an optical fiber, 12 an enzyme immobilized membrane, and 13 a ring.

In FIG. 1(a), the optical fiber 11, the enzyme immobilized membrane 12 and the ring 13 are made ready for use. In the method for producing the biosensor of the present invention, the enzyme immobilized membrane 12 is brought into intimate contact with the front end of the optical fiber 11. That is, as shown in FIG. 1(b), the enzyme immobilized membrane 12 obtained in the above-mentioned manner is put on the front end of the optical fiber 11. Then, the ring 13 is used to set the enzyme immobilized membrane 12 in place, thereby obtaining the biosensor of the present invention. No limitations are imposed on the material for the ring 13, and any material may be used, if it can fix the enzyme immobilized membrane 12 to the optical fiber 11. The ring 13 may be composed, for example, of silicone.

In FIGS. 1(a) and 1(b), the optical fiber 11 used has the front end formed at an angle of about 45°, i.e., a front end shaped like a sharp edge. The present invention is not limited to the use of an optical fiber having such a shape, but the optical fiber may have a flat front end. Moreover, the optical fiber having a front end at a sharper angle than the angle of 45° can be used.

The present invention will be described in greater detail by examples. It goes without saying that the scope of the invention is not limited to these examples.

### EXAMPLE 1

A mixed solution (weight ratio 1:1) of an alcohol oxidase (AOD, EC 1.1.3.13 A2404, 10-40 units/mg, Sigma-Aldrich Corp.) and PVA-SbQ (SPP-H-1(Bio), Toyo Gosei Kogyo Kabushiki Kaisha) as a photocrosslinkable resin was formed into a paste. A dialysis membrane (pore diameter 24 Å, membrane thickness 15 μm, Technicon) was coated and impregnated with the paste. The amount of the paste coated was 10 mg/cm².

Then, the paste-coated dialysis membrane was dried for 1 hour in a cold dark place, and then irradiated with light from a fluorescent lamp for 30 minutes. In this manner, AOD was entrapped and immobilized by photocrosslinking to obtain an enzyme immobilized membrane.

The resulting enzyme immobilized membrane was mounted on, and brought into intimate contact with, a front end portion of an oxygen-sensitive optical fiber by means of a silicone tube ring to obtain a biosensor according to the present invention. The oxygen-sensitive optical fiber used was FOXY-R of Ocean Optics with o.d. of 1.5 mm.

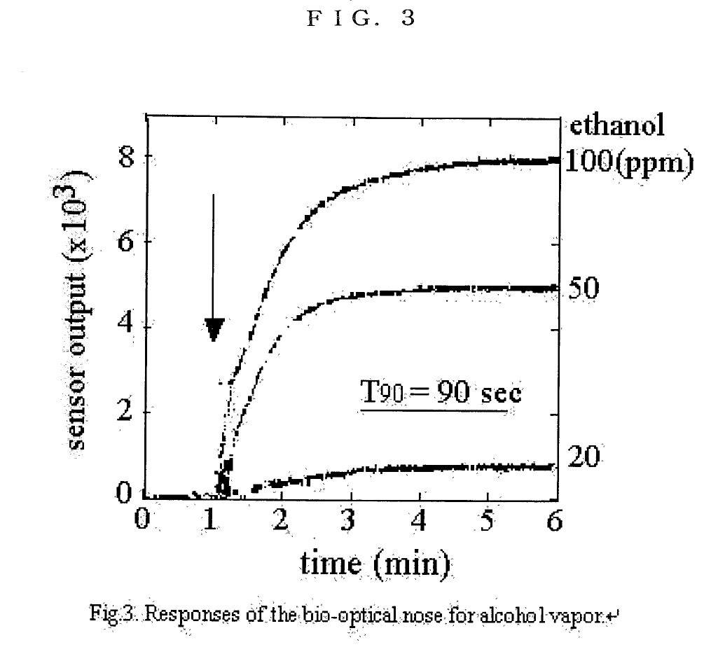

An ethanol gas was generated by use of a standard gas generator (Permeater, TYPE PD-1B-2, Kabushiki Kaisha Gastech), and the resulting ethanol gas was charged into a sample bag (G-4, 200×140×0.04 mm, ITOCHU Sunplus Kabushiki Kaisha). A front end portion of the biosensor produced in the above-described manner was inserted into the sample bag to load the ethanol gas into the biosensor. Decreases in the oxygen concentration by the oxidative catalytic reaction of the alcohol oxidase in the presence of the ethanol gas were measured with a computer via a spectroscope (MODEL S2000-FL, Ocean Optics) and an A/D converter (DAQ Card-700, PCMCIA-type A/D card, National Instruments). The ethanol gas concentration in the sample bag was set at 20, 50 and 100 ppm in making the measurements. The results are shown in FIG. 3.

FIG. 3 is a graph showing the responsiveness of the biosensor to the ethanol gas. In FIG. 3, the horizontal axis represents the elapsed after insertion of the front end of the biosensor into the sample bag (the insertion of the front end of the biosensor into the sample bag at 1 min), while the vertical axis represents the output responses of the biosensor. As shown in FIG. 3, the biosensor of the present invention showed the recovery of fluorescence (increase in output) of a ruthenium organic complex fixed to the front end portion of the optical fiber owing to the decrease in oxygen near the sensor associated with the oxidative catalytic reaction of the alcohol oxidase. Thus, the output responses according to the concentration of the ethanol gas were obtained. The time taken until the output response reached 90% of the peak was about 90 seconds.

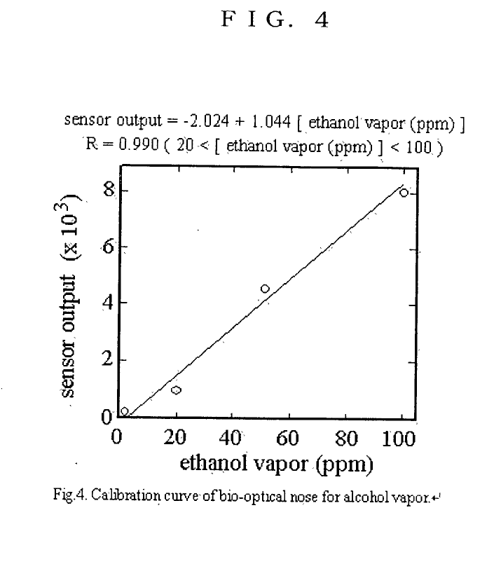

Whether or not the biosensor of the present invention has calibration characteristics was investigated. FIG. 4 is a graph showing a plot of the output steady-state values of the biosensor under an ethanol gas load.

As shown in FIG. 4, increases in the output proportional to the ethanol gas concentration were observed, showing that the ethanol gas can be quantitatively determined using the biosensor of the present invention. Quantitative determination of the ethanol concentration in the range of 0.7 to 51.5 ppm was possible, although relevant data are not presented.

### EXAMPLE 2

The same oxidoreductase as used in Example 1 was used, and an optical fiber having a flat front end was used to produce a biosensor of the shape shown in FIG. 2. That is, the biosensor was produced in the same way as in Example 1, except that the optical fiber was inserted into a tubular body of stainless, and that a partition tube was formed between the optical fiber and the tubular body. The type of the photocrosslinkable resin, and the method for crosslinking the resin are the same as in Example 1.

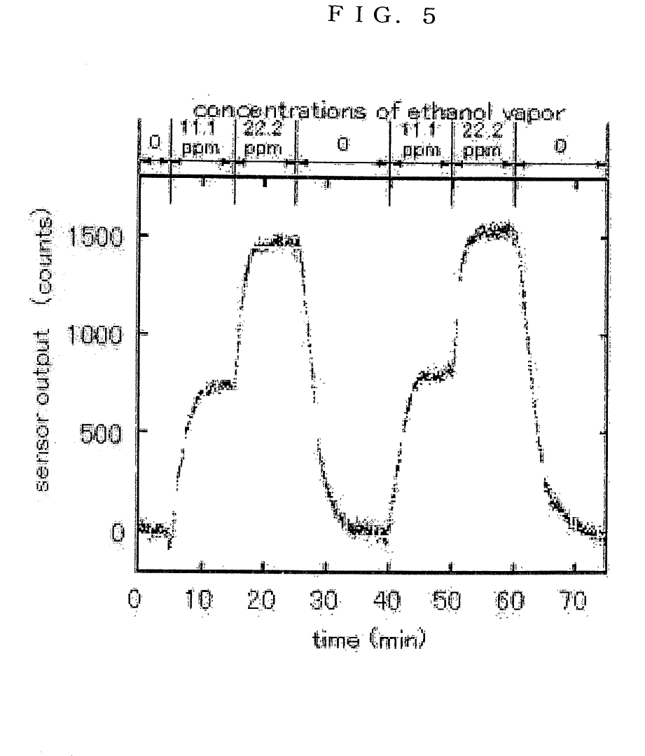

Measurements were made with the use of the biosensor, with a buffer (0.15 mmol/1 phosphate buffer, pH 7.0) being circulated in the tubular body. During this process, a front end portion of the sensor was loaded with a gas component at a flow rate of 200 ml/min by the gas generator used in Example 1, with the ethanol gas concentration being changed. The results are shown in FIG. 5. FIG. 5 is a graph showing the responsiveness of the biosensor to the ethanol gas. In FIG. 5, the horizontal axis represents the time elapsed after insertion of the front end of the biosensor into a sample bag, while the vertical axis represents the output responses of the biosensor. The top of the graph shows the concentration of the alcohol gas loaded onto the front end portion of the biosensor.

As shown in FIG. 5, when the alcohol gas concentration loaded onto the front end portion of the biosensor was changed, the output response of the biosensor changed correspondingly. From this outcome, the use of the biosensor of the present invention was found to permit continuous measurement of the gas component concentration.

### EXAMPLE 3

A biosensor was obtained by performing the same procedure as in Example 1, except that a flavin-containing monooxygenase (hereinafter referred to as FMO) was used instead of the alcohol oxidase. The flavin-containing monooxygenase exists as a plurality of isomers, and these isomers are known to be different in substrate specificity. Thus, three types of FMO (FMO1, FMO3 and FMO5) were used. Using FMO1, FMO3 and FMO5, outputs of trimethylamine, methyl mercaptan and dimethyl sulfide were compared. The respective FMO's showed output patters characteristic of the respective substrates. Quantitative determination was possible in the concentration range of 0.31 to 125 ppm for trimethylamine, 0.37 to 2.23 ppm for methyl mercaptan, and 2.1 to 126 ppm for dimethyl sulfide.

### EXAMPLE 4

An odor measuring device, which was a 4-channel bionose having a total of four biosensors, was produced using the biosensor obtained in Example 1 and the biosensor obtained in Example 3. Shochu (Japanese distilled spirit), marine fish, radish and Nori (purple laver), containing ethanol, trimethylamine, methyl mercaptan and dimethyl sulfide, respectively, as main odor components, were measured for odors by use of the odor measuring device.

Shochu, marine fish, radish and Nori were each collected into the sample bag used in Example 1. Then, the measuring portion of the odor measuring device (front end portions of the four biosensors) was inserted into the sample bag to measure the odor components. The results are shown in Table 1.

TABLE 1

| | | | Methyl | Dimethyl |
|---|---|---|---|---|
| | Ethanol | Trimethylamine | mercaptan | sulfide |
| Shochu | 40 | ND | ND | ND |
| Marine | ND | 0.6 | ND | ND |
| fish | | | | |
| Radish | 10 | ND | 2.2 | ND |
| Nori | ND | ND | ND | 7 |

In Table 1, ND denotes “Not detected”, and the figures are in ppm. As shown in Table 1, the main odor component was confirmed to be ethanol for Shochu, trimethylamine for marine fish, and dimethyl sulfide for Nori. Radish was confirmed to contain ethanol and methyl mercaptan. These results were not contradictory to the reported values.

While the present invention has been described by the foregoing Examples, it is to be understood that the invention is not limited thereby, but may be varied in many other ways. Such variations are not to be regarded as a departure from the spirit and scope of the invention, and all such modifications as would be obvious to one skilled in the art are intended to be included within the scope of the appended claims.

What is claimed is:

1. A biosensor comprising an enzyme immobilized membrane in intimate contact with a front end of an optical fiber.

2. The biosensor according to claim 1, wherein the enzyme is an oxidoreductase, a dehydrogenase, or a luminescent enzyme.

3. The biosensor according to claim 1 or 2, wherein the optical fiber is an oxygen-sensitive optical fiber, a pH-sensitive optical fiber, or a luminescence-sensitive optical fiber.

4. The biosensor according to claim 1 or 2, wherein the optical fiber is an oxygen-sensitive optical fiber having a ruthenium organic complex fixed to a front end portion thereof.

5. The biosensor according to any one of claims 2 to 4, wherein the oxidoreductase is an enzyme which consumes or generates oxygen upon reaction with a substrate.

6. The biosensor according to any one of claims 1 to 5, wherein the membrane is a dialysis membrane.

7. The biosensor according to any one of claims 1 to 6, wherein the optical fiber is inserted into a tubular body and a liquid can be circulated in the tubular body.

8. An odor measuring device having at least one of the biosensors according to claims 1 to 7.

9. A method for producing a biosensor, comprising the steps of:
coating and impregnating a dialysis membrane with an enzyme and a photocrosslinkable resin, and then crosslinking the photocrosslinkable resin to immobilize the enzyme in the dialysis membrane, thereby obtaining an enzyme immobilized membrane; and
bringing the enzyme immobilized membrane into intimate contact with a front end an optical fiber.

10. The method for producing a biosensor according to claim 9, wherein an optical fiber having a ruthenium organic complex fixed to a front end portion thereof is used as the optical fiber.

11. The method for producing a biosensor according to claim 9 or 10, wherein an oxidoreductase which consumes or generates oxygen upon reaction with a substrate is used as the enzyme.
